(19) United States
(12) Patent Application Publication
(10) Pub. No.: US 2024/0059110 A1
(43) Pub. Date: Feb. 22, 2024

(54) Trailer Hitch System

(71) Applicant: Edward Mills, Pawleys Island, SC (US)

(72) Inventor: Edward Mills, Pawleys Island, SC (US)

(21) Appl. No.: 18/295,019

(22) Filed: Apr. 3, 2023

Related U.S. Application Data
(60) Provisional application No. 63/398,588, filed on Aug. 17, 2022.

(51) Int. Cl. B60D 1/06; B60D 1/36

(52) U.S. Cl. CPC B60D 1/06; B60D 1/36

(57) ABSTRACT

The present invention relates to a trailer hitch system for identifying compatible ball mounts and trailer couplers. The system is primarily comprised of a ball mount, a trailer coupler, and a method of use. The ball mount can be attached to a receiver tube of a towing vehicle. The trailer coupler can then be attached to a trailer such that a hitch ball housing of the coupler can receive a trailer ball of the ball mount. The coupler and ball mount are each comprised of an indicia that are preferably identical to indicate to a user that a ball mount is compatible with a coupler.

### CROSS-REFERENCE TO RELATED APPLICATION

The present application claims priority to, and the benefit of, U.S. Provisional Application No. 63/398,588, which was filed on Aug. 17, 2022, and is incorporated herein by reference in its entirety.

### FIELD OF THE INVENTION

The present invention relates generally to the field of trailer towing. More specifically, the present invention relates to a trailer hitch system. The system is primarily comprised of a ball mount, a trailer coupler, and a method of use. The ball mount can be attached to a receiver tube of a towing vehicle. The trailer coupler can then be attached to a trailer such that the hitch ball housing of the coupler can receive a trailer ball of the ball mount. The coupler and ball mount are each comprised of an indicia that are preferably identical to indicate to a user that a ball mount is compatible with a coupler. Accordingly, the present disclosure makes specific reference thereto. Nonetheless, it is to be appreciated that aspects of the present invention are also equally applicable to other like applications, devices, and methods of manufacture.

### BACKGROUND

Towing trailers, trailer balls, and trailer hitch sizes can be difficult to match since there is typically no indicator as to which two sizes or configuration of the ball and hitch are compatible. As a result, a user must then visually estimate whether a hitch and ball are compatible, select a hitch and ball, and test fit each. This process can be incredibly frustrating and time-consuming. In addition, improper hitch and ball connection due to different sizing can lead to trailers coming loose during towing. This creates a significant road safety hazard.

Therefore, there exists a long-felt need in the art for an improved trailer ball and trailer hitch system. There also exists a long-felt need in the art for a trailer hitch system that allows a user to easily size and identify compatible trailer hitches and trailer balls. In addition, there exists a long-felt need in the art for a trailer hitch system that allows a user to easily size and identify compatible trailer hitches and trailer balls without having to test fit the hitch and the ball.

The subject matter disclosed and claimed herein, in one embodiment thereof, comprises a trailer hitch system. The system is primarily comprised of a ball mount, a trailer coupler, and a method of use. The ball mount can be attached to a receiver tube of a towing vehicle. The trailer coupler can then be attached to a trailer such that a hitch ball housing of the coupler can receive a trailer ball of the ball mount. The coupler and ball mount are each comprised of an indicia. The indicia of the coupler and ball mount are preferably identical to indicate to a user that a ball mount is compatible with a coupler.

In this manner, the trailer hitch system of the present invention accomplishes all the foregoing objectives and provides a trailer hitch system that allows a user to easily size and identify compatible trailer hitches and trailer balls. Due to the indicia of the ball mount and coupler, the system does not require a user to test fit the hitch and the ball. In addition, compatible hitches and balls can be easily identified via the indicia, especially in a scenario when a user has a plurality of different hitches and balls of differing sizes.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trailer hitch system. The system is primarily comprised of a ball mount, a trailer coupler, and a method of use. The ball mount attaches to the receiver tube of a towing vehicle such that a body of the second end of the ball mount is inserted into the receiver tube. The body is preferably comprised of at least one opening that aligns with at least one opening of the receiver tube such that at least one pin can be inserted through the tube and through the body to secure the ball mount within the tube while towing. The first end of the ball mount is comprised of at least one trailer ball.

The system is also comprised of a trailer coupler having a body that can be placed over a trailer frame. The body is comprised of at least one opening that preferably aligns with at least one opening of the frame such that at least one fastener can be used to secure the body to the frame. The coupler is also comprised of a hitch ball housing that receives the trailer ball. The coupler is also comprised of a coupler latch. When in the locked position, the latch retains the trailer ball within the housing (i.e., when the coupler is being used). When unlocked, the ball can be removed from the housing.

The ball mount and the coupler are both comprised of at least one indicia. The indicia may be in the form of a color, a pattern, a logo, an emblem, an image, a symbol, a design, a letter, a word, a character, an animal, an advertisement, or a brand. In the preferred embodiment, a coupler can accommodate a trailer ball size of the ball mount, wherein both the coupler and the mount have the same indicia so a user can quickly and easily identify which coupler is compatible with which mount.

The system is also comprised of a method of use. First, a user views a first indicia on a ball mount and a second indicia on a trailer coupler to determine if both indicia are the same, thereby indicating that the size of trailer ball is compatible with the size of the hitch ball housing on the coupler. Next, the body of a ball mount is placed within a receiver tube of a towing vehicle such that at least one opening of the mount aligns with at least one opening of the receiver tube and at least one pin is inserted through both openings to secure the mount to the tube. Next, the trailer coupler is placed over a trailer frame such that at least one opening in the coupler aligns with at least one opening of the trailer frame and at least one fastener is placed through both openings and secures the coupler to the frame. A user can then position the trailer ball underneath the housing of the coupler while pulling the latch upward away from the coupler. Then, once the hitch ball housing has been lowered onto the ball, the latch can be released to secure the housing around the ball.

Accordingly, the trailer hitch system of the present invention is particularly advantageous as it provides a trailer hitch system that allows a user to easily size and identify compatible trailer hitches and trailer balls. Due to the indicia of the ball mount and coupler, the system does not require a user to test fit the hitch and the ball. In addition, compatible hitches and balls can be easily identified via the indicia, especially in a scenario when a user has a plurality of different hitches and balls of differing sizes. In this manner, the trailer hitch system overcomes the limitations of existing trailer hitches and trailer balls known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The Description Refers to Provided Drawings in which Similar Reference Characters Refer to Similar Parts Throughout the Different Views, and in which:

FIG. 1 illustrates a side cross-sectional view of one potential embodiment of a trailer hitch system of the present invention in accordance with the disclosed architecture;

FIG. 2 illustrates a perspective view of one potential embodiment of a trailer hitch system of the present invention in accordance with the disclosed architecture; and

FIG. 3 illustrates a flowchart of a method of using one potential embodiment of a trailer hitch system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved trailer ball and trailer hitch system. There also exists a long-felt need in the art for a trailer hitch system that allows a user to easily size and identify compatible trailer hitches and trailer balls. In addition, there exists a long-felt need in the art for a trailer hitch system that allows a user to easily size and identify compatible trailer hitches and trailer balls without having to test fit the hitch and the ball.

The present invention, in one exemplary embodiment, is comprised of a trailer hitch system primarily comprised of a ball mount, a trailer coupler, and a method of use. The ball mount attaches to the receiver tube of a towing vehicle such that a body of the second end of the ball mount is inserted into the receiver tube. The body is preferably comprised of at least one opening that aligns with at least one opening of the receiver tube. In this manner, at least one pin can be inserted through the tube and through the body to secure the ball mount within the tube while towing. The first end of the ball mount is comprised of at least one trailer ball.

The system is also comprised of a trailer coupler having a body that can be placed over a trailer frame, wherein the body has at least one opening that preferably aligns with at least one opening of the frame such that at least one fastener can be used to secure the body to the frame. The coupler is also comprised of a hitch ball housing that receives the trailer ball. The coupler is also comprised of a coupler latch that retains the trailer ball within the housing when in a locked position (i.e., when the coupler is being used). When unlocked, the ball can be removed from the housing.

The ball mount and the coupler are both comprised of at least one indicia that may be in the form of a color, a pattern, a logo, an emblem, an image, a symbol, a design, a letter, a word, a character, an animal, an advertisement, or a brand. In the preferred embodiment, a coupler can accommodate a trailer ball size of the ball mount, wherein both the coupler and the mount have the same indicia. In this manner, a user can quickly and easily identify which coupler is compatible with which mount.

The system is also comprised of a method of use. First, a user views a first indicia on a ball mount and a second indicia on a trailer coupler to determine if both indicia are the same, thereby indicating that the size of trailer ball is compatible with the size of hitch ball housing on the coupler. Next, the body of a ball mount is placed within a receiver tube of a towing vehicle such that at least one opening of the mount aligns with at least one opening of the receiver tube and at least one pin is inserted through both openings to secure the mount to the tube. Next, the trailer coupler is placed over a trailer frame such that at least one opening in the coupler aligns with at least one opening of the trailer frame and at least one fastener is placed through both openings and secures the coupler to the frame. A user can then position the trailer ball underneath the housing of the coupler while pulling the latch upward away from the coupler. Then, once the hitch ball housing has been lowered onto the ball, the latch can be released to secure the housing around the ball.

Accordingly, the trailer hitch system of the present invention is particularly advantageous as it provides a trailer hitch system that allows a user to easily size and identify compatible trailer hitches and trailer balls. Due to the indicia of the ball mount and coupler, the system does not require a user to test fit the hitch and the ball. In addition, compatible hitches and balls can be easily identified via the indicia, especially in a scenario when a user has a plurality of different hitches and balls of differing sizes. In this manner, the trailer hitch system overcomes the limitations of existing trailer hitches and trailer balls known in the art.

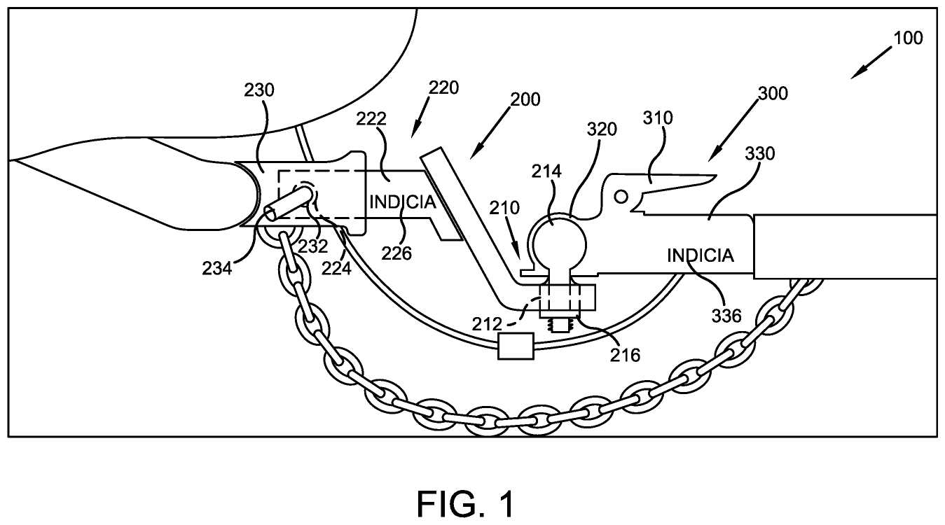

Referring initially to the drawings, FIG. 1 illustrates a side cross-sectional view of one potential embodiment of a trailer hitch system 100 of the present invention in accordance with the disclosed architecture. The system 100 is primarily comprised of a ball mount 200, a trailer coupler 300, and a method of use 400. All components of the ball mount 200 and trailer coupler 300 are preferably made from a metal material such as, but not limited to, stainless steel or aluminum. The material is preferably corrosion-resistant to protect against rust.

The ball mount 200 attaches to the receiver tube 230 of a towing vehicle. More specifically, the body 222 of the second end 220 of the ball mount 200 is inserted into a receiver tube 230 (which is attached to a towing vehicle). The body 222 is preferably comprised of at least one opening 224. The opening 224 aligns with at least one opening of the receiver tube 230. In this manner, at least one pin 234 can be inserted through the tube 230 and through the body 222 to secure the ball mount 200 within the tube 230 while towing. The pin 234 may be any pin known in the art but is preferably a hitch pin.

The first end 210 of the ball mount 200 is comprised of at least one trailer ball 214. The trailer ball 214 may be any size known in the art. In one embodiment, the ball 214 is fixedly attached (i.e., welded to the first end 210).

In another embodiment, the ball 214 is removably attached to the first end 210. In this embodiment, the trailer ball 214 is secured within the opening via at least one fastener 216. In the preferred embodiment, the trailer ball 214 is comprised of a threaded trailer ball 214 wherein the fastener 216 is a nut that can be screwed onto the ball 214 to secure the ball 214 within the opening. The fastener 216 may also be, but is not limited to, a clip, a clamp, etc.

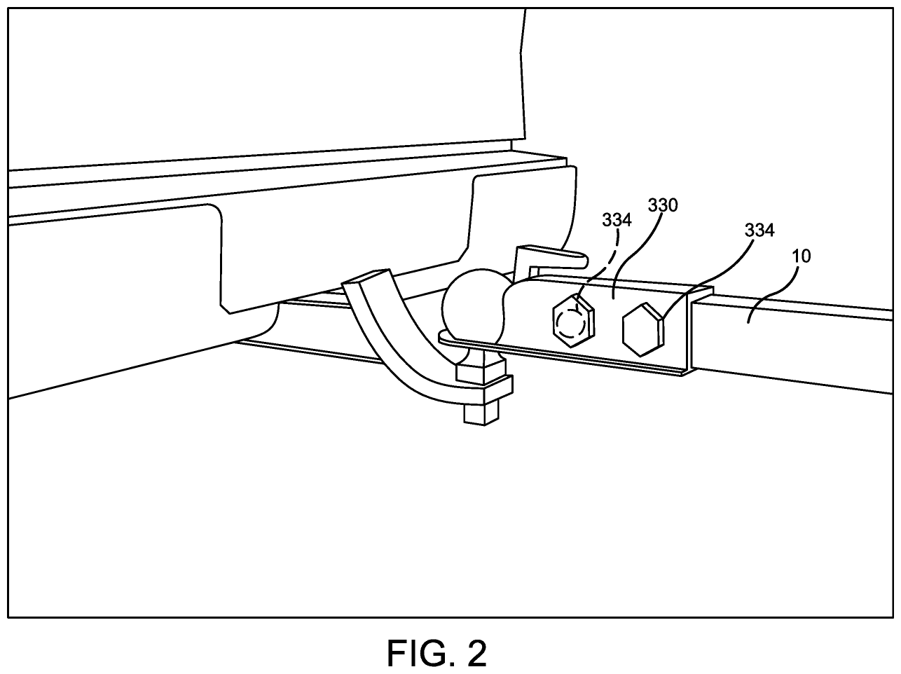

The system 100 is also comprised of a trailer coupler 300. The coupler 300 is comprised of a body 330 that can be placed over a trailer frame 10. The body 330 is comprised of at least one opening 332. The opening 332 preferably aligns with at least one opening 12 of the frame 10 such that at least one fastener 334 can be used to secure the body 330 to the frame 10, as seen in FIG. 2. The fastener 334 may include, but is not limited to, a bolt, a nut and bolt assembly, etc.

The coupler 300 is also comprised of a hitch ball housing 320. The housing 320 receives the trailer ball 214. The coupler 300 is also comprised of a coupler latch 310. When in the locked position, the latch 310 retains the trailer ball 214 within the housing 320 (i.e., when the coupler 300 is being used). When unlocked, the ball 214 can be removed from the housing 320. The coupler latch 310 may be any style of coupler and/or ball hitch securing mechanism known in the art.

The ball mount 200 is comprised of at least one indicia 226. The indicia 226 may be in the form of a color, a pattern, a logo, an emblem, an image, a symbol, a design, a letter, a word, a character, an animal, an advertisement, or a brand. Similarly, the trailer coupler 300 is comprised of at least one indicia 336. The indicia 336 may be in the form of a color, a pattern, a logo, an emblem, an image, a symbol, a design, a letter, a word, a character, an animal, an advertisement, or a brand. Both indicia 226,336 may be located on all or part of the mount 200 and coupler 300.

In the preferred embodiment, a coupler 300 can accommodate a trailer ball 214 size of the ball mount 200, wherein both the coupler 300 and the mount 200 have the same indicia 226,336. In the preferred embodiment, the indicia 226,336 is a color, wherein both all or part of the mount 300 and coupler 300 are the same color. In this manner, a user can quickly and easily identify which coupler 300 is compatible with which mount 200. This is especially useful for users with multiple couplers 300 and ball mounts 200 of different sizes.

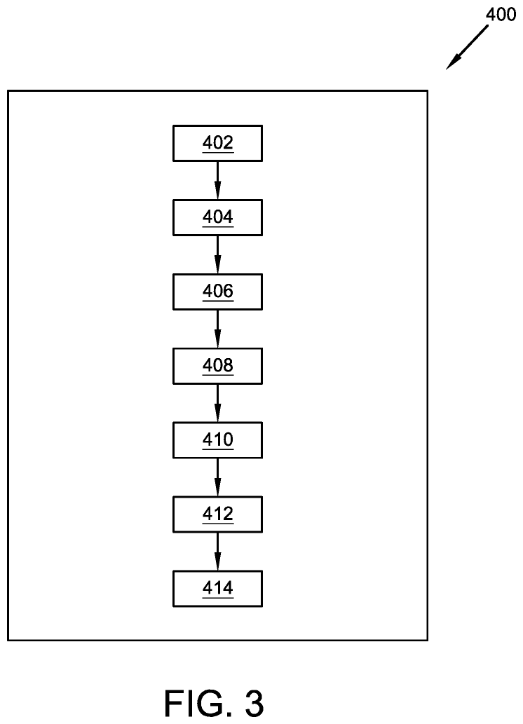

FIG. 3 illustrates a flowchart of a method of using 400 one potential embodiment of a trailer hitch system 100 of the present invention in accordance with the disclosed architecture. The system 100 is also comprised of a method of use 400. First, a user views a first indicia 226 on a ball mount 200 and a second indicia 336 on a trailer coupler 300 to determine if both indicia 226,336 are the same [Step 402]. If both indicia 226,336 are the same, this ensures the size of trailer ball 214 of the mount 200 is compatible with the size of hitch ball housing 320 on the coupler 300. Next, the body 222 of a ball mount 200 is placed within a receiver tube 230 of a towing vehicle such that at least one opening 224 of the mount 200 aligns with at least one opening 232 of the receiver tube 230 [Step 404]. Then, at least one pin 234 is inserted through both openings 224,232 to secure the mount 200 to the tube 230 [Step 406]. Next, the trailer coupler 300 is placed over a trailer frame 10 such that at least one opening 332 in the coupler 300 aligns with at least one opening 12 of the trailer frame [Step 408]. Then, at least one fastener 334 is placed through both openings 12,332 and secures the coupler 300 to the frame 10 [Step 410]. A user can then position the trailer ball 214 underneath the housing 320 of the coupler 300 while pulling the latch 310 upward away from the coupler 300 [Step 412]. Then, once the hitch ball housing 320 has been lowered onto the ball 214, the latch 310 can be released to secure the housing 320 around the ball 214 [Step 414].

It should be noted that the trailer ball 214, hitch ball housing 320, and any other part of the ball mount 200 and/or trailer coupler 300 may be any size in different embodiments. In one embodiment, the system 100 is comprised of a plurality of ball mounts 200 and couplers 300, each of different matching sizes (i.e., trailer balls 214 and housings 320) and each with different identifying indicia 226,336. In this manner, a user has a plurality of different ball mount 200 and coupler 300 sizes, and compatible mounts 200 and couplers 300 can be identified.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trailer hitch system” and “system” are interchangeable and refer to the trailer hitch system 100 of the present invention.

Notwithstanding the foregoing, the trailer hitch system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trailer hitch system 100 as shown in the FIGS. are for illustrative purposes only, and that many other sizes and shapes of the trailer hitch system 100 are well within the scope of the present disclosure. Although the dimensions of the trailer hitch system 100 are important design parameters for user convenience, the trailer hitch system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trailer hitch system comprising:
a ball mount comprised of a trailer ball, a first opening, and a first indicia; and
a trailer coupler comprised of a hitch ball housing, a coupler latch, a second opening, and a second indicia.

2. The trailer hitch system of claim 1, wherein the first indicia is comprised of a color, a pattern, a logo, an emblem, an image, a symbol, a design, a letter, a word, a character, an animal, an advertisement or a brand.

3. The trailer hitch system of claim 1, wherein the second indicia is comprised of a color, a pattern, a logo, an emblem, an image, a symbol, a design, a letter, a word, a character, an animal, an advertisement or a brand.

4. The trailer hitch system of claim 1, wherein the first indicia is identical to the second indicia.

5. A trailer hitch system comprising:
a ball mount comprised of a trailer ball, a first opening, second opening, a fastener, and a first indicia; and
a trailer coupler comprised of a hitch ball housing, a coupler latch, a third opening, and a second indicia.

6. The trailer hitch system of claim 5, wherein the first indicia is comprised of a color.

7. The trailer hitch system of claim 5, wherein the second indicia is comprised of a color.

8. The trailer hitch system of claim 5, wherein the first indicia is identical to the second indicia.

9. The trailer hitch system of claim 5, wherein the trailer ball is comprised of a threaded trailer ball.

10. The trailer hitch system of claim 5, wherein the fastener is comprised of a nut.

11. The trailer hitch system of claim 5, wherein the hitch ball housing is sized and configured to receive the trailer ball.

12. The trailer hitch system of claim 5 further comprised of a receiver tube.

13. The trailer hitch system of claim 12, wherein the receiver tube is comprised of a fourth opening.

14. The trailer hitch system of claim 13, wherein the fourth opening aligns with the second opening.

15. The trailer hitch system of claim 5, wherein the pin is comprised of a hitch pin.

16. The trailer hitch system of claim 5, wherein the fastener is comprised of a clip.

17. The trailer hitch system of claim 5, wherein the fastener is comprised of a clamp.

18. A method of using a trailer hitch system, the method comprising the steps of:
determining if a first indicia on a ball mount matches a second indicia on a trailer coupler;
placing the ball mount in a receiver tube such that a first opening of the ball mount aligns with a second opening of the receiver tube;
placing a first fastener through the first opening of the ball mount and the second opening of the receiver tube;
placing a trailer coupler over a trailer frame such that a third opening of the trailer coupler aligns with fourth opening of the trailer frame;
placing a second fastener through the third opening of the trailer coupler and the fourth opening of the trailer frame;
positioning a trailer ball of the ball mount underneath a hitch ball housing of the trailer coupler;
pulling a coupler latch upward;
lowering the hitch ball housing onto the trailer ball; and
releasing the coupler latch.

19. The method of using a trailer hitch system of claim 18, wherein the first indicia is comprised of a color.

20. The method of using a trailer hitch system of claim 18, wherein the second indicia is comprised of a color.
